(19) United States
(12) Patent Application Publication
(10) Pub. No.: US 2017/0157442 A1
(43) Pub. Date: Jun. 8, 2017

(54) WATER MIST FIRE SUPPRESSION DEVICE AND METHOD OF MANUFACTURING

(71) Applicants: Arto HUOTARI, Vantaa (FI); MARIOFF CORPORATION OY, Vantaa (FI)

(72) Inventors: Arto Huotari, Helsinki (FI); Harri Mattila, Hyvinkää (FI); Esko Lehto, Vantaa (FI); Sami Syrjänen, Vantaa (FI); Juhani Mattila, Hyvinkää (FI)

(21) Appl. No.: 15/321,538

(22) PCT Filed: Jul. 11, 2014
(86) PCT No.: PCT/FI2014/050569

§ 371 Date: Dec. 22, 2016

(51) Int. Cl. A62C 31/05; B05B 1/26

(52) U.S. Cl. CPC A62C 31/05; B05B 1/262; A62C 99/0072

(57) ABSTRACT

A water mist fire suppression device includes a nozzle body disposed about a central axis. Also included a nozzle arrangement configured to expel water. The nozzle arrangement includes an annular groove. The nozzle arrangement also includes a micro nozzle extending from a water plenum to the annular groove, wherein the micro nozzle is angularly oriented from the central axis. The nozzle further includes a deflector lip located proximate an outlet of the nozzle, wherein the deflector lip is positioned to contact water exiting the outlet of the nozzle arrangement.

### BACKGROUND OF THE INVENTION

The embodiments herein relate to water mist fire suppression systems and, more particularly, to an automatic water mist nozzle or device (also referred to herein as a “sprinkler”) as well as a method of manufacturing such a nozzle.

Traditional fire suppression systems (e.g., sprinkler systems) spray water into an area to extinguish or contain a fire. Traditional systems rely upon a relatively large volume of water to sufficiently wet the contents of the area and to apply water directly onto the fire. Conventional wisdom has been to spray water directly at the walls of an enclosed space such as a room. Some industry standards require spraying water directly onto the walls at a height that is a minimum distance from the ceiling. Some of the water applied to the walls soaks the wall material. Some of the water splashes off the wall and falls onto the floor, furniture or other items in the room.

One drawback to the conventional approach is that it requires a relatively large volume of water or other fire suppression fluid. Soaking the walls and contents of a room increases the likelihood of having to repair or replace the wall materials and furniture or other items in the room, even if they were not damaged by a fire. Water will seep to surrounding areas and floors below and will cause water damage in surrounding areas. Often, damages caused by the water exceed the direct damages caused by the fire. Another drawback to such systems is that various room sizes and configurations typically require different arrangements of multiple nozzles within the room or area within which fire suppression is desired. This introduces additional complexity for installers and designers of fire suppression systems.

Water mist systems use less water than traditional sprinkler system thus reducing the above-described water damage caused by wetting of the surrounding structures. Water mist systems use small water particles to fill the space to block radiant heat transfer and to wet the volume surfaces. Water mist is applied as jets from the nozzle to the protected volume and the jets penetrate to the fire, thereby cooling down the fire and replacing oxygen with water mist. For water mist jet penetration, a direct line to a fire is important. For best performance, the nozzle must spray directly to the fire region or near the fire region.

Efforts have been made to spray water directly underneath a sprinkler device. A common requirement is referred to as an “under-one test” where a fire is started directly beneath the water mist nozzle. Unfortunately, the efforts to this point have resulted in unsuitable spray characteristics and/or required complicated manufacturing and assembly processes.

### BRIEF DESCRIPTION OF THE INVENTION

According to one embodiment, a water mist fire suppression device includes a nozzle body disposed about a central axis. Also included is a nozzle arrangement configured to expel water. The nozzle includes an annular groove. The nozzle also includes a hole (also referred to as a “micro nozzle”) extending from a water plenum to the annular groove, wherein the micro nozzle is angularly oriented from the central axis. The nozzle further includes a deflector lip located proximate an outlet of the nozzle, wherein the deflector lip is positioned to contact water exiting the outlet of the nozzle arrangement.

In addition to one or more of the features described above, or as an alternative, further embodiments may include that the micro nozzle is angularly oriented from the central axis at an angle of about 15 degrees to about 50 degrees.

In addition to one or more of the features described above, or as an alternative, further embodiments may include that the annular groove is at least partially defined by an axial wall portion, a radially inner wall portion, and a radially outer wall portion, wherein the micro nozzle extends through the axial wall portion.

In addition to one or more of the features described above, or as an alternative, further embodiments may include that the micro nozzle is aligned perpendicularly to the axial wall portion of the annular groove.

In addition to one or more of the features described above, or as an alternative, further embodiments may include that the deflector lip is formed on the radially outer wall portion.

In addition to one or more of the features described above, or as an alternative, further embodiments may include that the micro nozzle is configured to route water from the water plenum to the annular groove, the micro nozzle aligned to expel the water into the annular groove in a direction that contacts the deflector lip.

In addition to one or more of the features described above, or as an alternative, further embodiments may include that the radially outer wall portion comprises a first segment and a second segment, the second segment forming the deflector lip.

In addition to one or more of the features described above, or as an alternative, further embodiments may include that the second segment is angularly displaced from the first segment.

In addition to one or more of the features described above, or as an alternative, further embodiments may further include a plurality of nozzles, each of the nozzles comprising the annular groove, the micro nozzle and the deflector lip.

According to another embodiment, a method of manufacturing a water mist fire suppression device is provided. The method includes machining a bulb cage to be integrally formed with a nozzle body. The method also includes machining an annular groove about a central axis of the nozzle body. The method further includes drilling at least one micro nozzle through the nozzle body from the annular groove to a water plenum of the nozzle body. The method yet further includes integrally forming a deflector lip within the annular groove proximate an outlet of a nozzle, wherein the deflector lip is positioned to interfere with a water spray exiting the at least one micro nozzle.

In addition to one or more of the features described above, or as an alternative, further embodiments may include that drilling the at least one micro nozzle comprises drilling through the axial wall portion to the water plenum at an angle perpendicular to the axial wall portion.

In addition to one or more of the features described above, or as an alternative, further embodiments may include that integrally forming the deflector lip comprises pressure turning a portion of the radially outer wall portion.

In addition to one or more of the features described above, or as an alternative, further embodiments may include that integrally forming the deflector lip forms a first segment of the radially outer wall portion and a second segment of the radially outer wall portion, the second segment angularly oriented relative to the first segment.

In addition to one or more of the features described above, or as an alternative, further embodiments may include that drilling the at least one micro nozzle comprises drilling the micro nozzle at an angle of about 15 degrees to about 50 degrees relative to the central axis of the nozzle body.

In addition to one or more of the features described above, or as an alternative, further embodiments may include that integrally forming the deflector lip comprises positioning the deflector lip to redirect a water spray expelled from the micro nozzle.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a fire suppression system in operation;

FIG. 2 is a cross-sectional view of a fire suppression water spray device of the fire suppression system;

FIG. 3 is a cross-sectional view of a nozzle region of the fire suppression water spray device according to an embodiment;

FIG. 4 is a cross-sectional view of a final manufactured configuration of the nozzle region of the fire suppression water spray device according to another embodiment; and

FIG. 5 is a schematic view of the nozzle region of the fire suppression water spray device illustrating various dimensions.

### DETAILED DESCRIPTION OF THE INVENTION

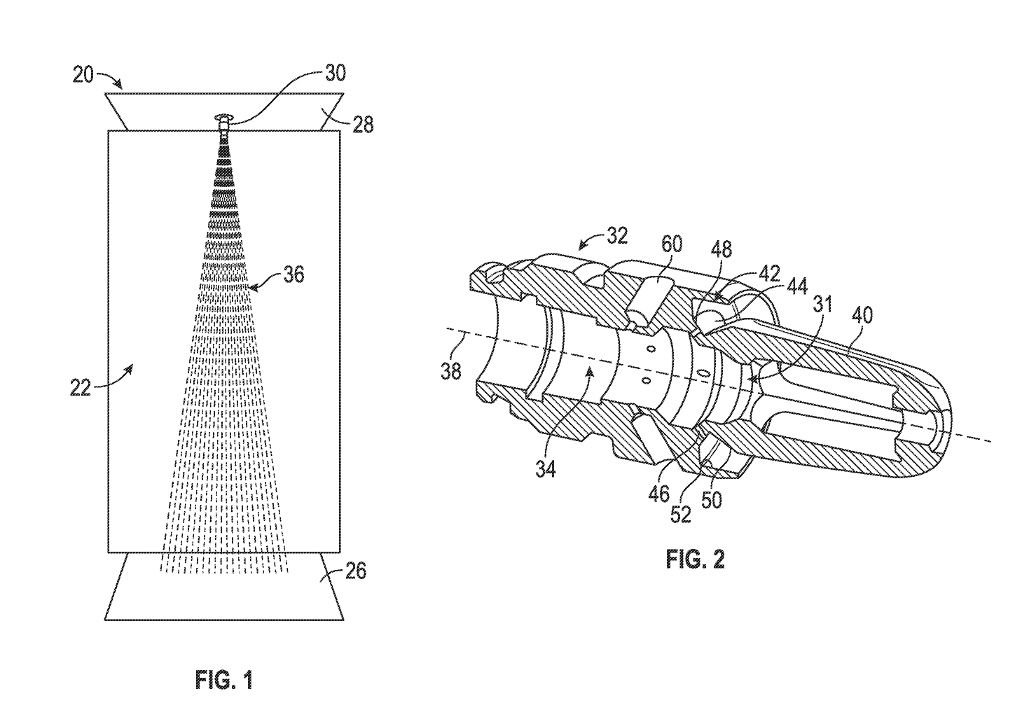

Referring to FIG. 1, schematically illustrated is a fire suppression system 20 that is used for suppressing or extinguishing a fire within an area 22. In the illustrated embodiment, the area 22 is a generally enclosed space such as a room within a building. The area 22 includes a generally horizontal surface 26. In one example, the horizontal surface 26 is a floor. In another example, the horizontal surface 26 is a platform within the area 22. A ceiling 28 is parallel to the surface 26 and is typically located proximate the top of the area 22. Other example areas or rooms may include angled surfaces that are not parallel to the surface 26 or may include surfaces at different heights relative to the surface 26. It is to be appreciated that the above examples of the area 22 and the horizontal surface 26 are merely illustrative of environments that the fire suppression system 20 may be employed within. To be clear, a target area is what is referred to by the horizontal surface 26, and the target area may include any surface of any orientation and may contain or include numerous contemplated articles, such as furniture, machinery, storage items, etc.

Fire suppression fluid, such as water, is provided by a source (not illustrated) through a piping network to a fire suppression water spray device 30. The fire suppression water spray device 30 includes a nozzle body 32 (FIG. 2) having a water plenum 34 that is in fluid communication with one or more nozzles for expulsion to the area 22. The fire suppression water spray device 30 introduces fire suppression fluid into the area 22 when needed. The fire suppression water spray device 30 is positioned within the area 22 and configured to direct the fire suppression fluid along a primary trajectory 36 that is aimed directly at the generally horizontal surface 26. In this example, the primary trajectory 36 is aimed directly at a floor surface 26.

The example primary trajectory 36 is aligned substantially perpendicularly to the generally horizontal surface 26. A relatively steep angle of orientation of the primary trajectory 36 ensures that most of the fire suppression fluid exiting the fire suppression water spray device 30 is aimed directly at the floor or generally horizontal surface 26.

Referring now to FIG. 2, the fire suppression water spray device 30 is illustrated in greater detail. The nozzle body 32 is oriented about a central axis 38 that extends longitudinally through the nozzle body 32. The water plenum 34 located at an interior location of the nozzle body 32 is in fluid communication with at least one, but typically a plurality of nozzles for expulsion of fire suppression fluid (e.g., water). A bulb cage 40 is operatively coupled to the nozzle body 32. In one embodiment, the bulb cage 40 is machined to be integrally formed with the nozzle body 32 to form a permanent securement thereto. To achieve expulsion of the fire suppression fluid in the primary trajectory 36, the fire suppression water spray device 30 is configured to do so while expelling the fire suppression fluid around the bulb cage 40.

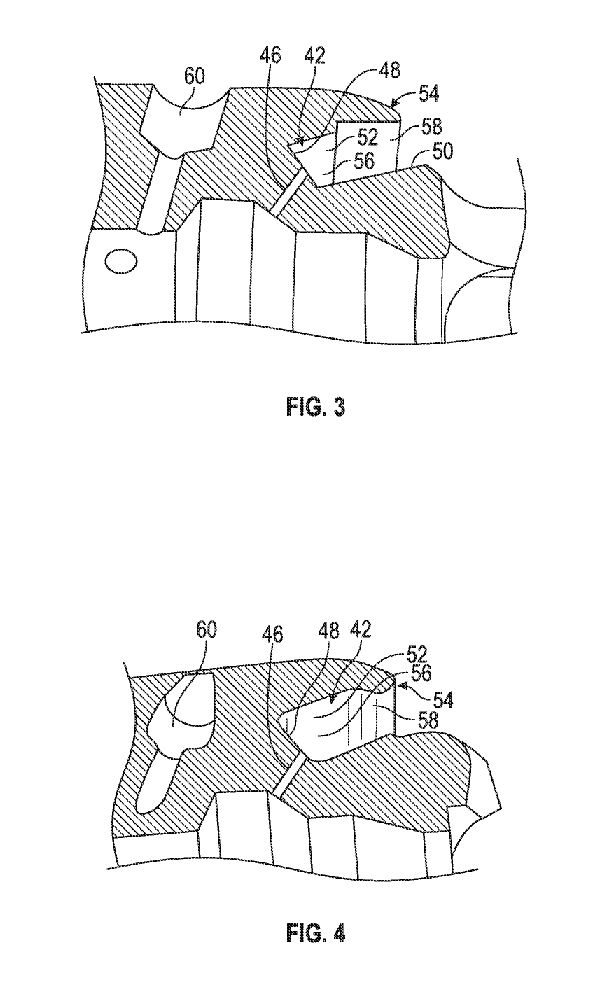

A nozzle arrangement 42 is formed proximate an end of the nozzle body 32 (also shown in FIGS. 3 and 4). It is to be appreciated that the device 30 includes various components configured to block the water flow through a center hole 31, thereby ensuring that desirable water flow will be directed through the holes 46 (also referred to herein as micro nozzles). The micro nozzles extend from the water plenum 34 of the nozzle body 32 and through nozzle body 32 to the surrounding environment. The term micro nozzle, as employed herein, refers to a hole, such as a drilled hole, defined by the nozzle body 32, which has a small cross sectional area in relation to the system piping area. For example, in one embodiment the pipe providing water to nozzle has an inner diameter of about 8 mm, while the micro nozzle has a diameter of equal to or less than about 1.4 mm. Viewed in terms of cross-sectional area, such an embodiment has a pipe are of about 50.3 square mm feeding water to the sprinkler nozzle, which has micro nozzle drillings on the nozzle body 32. These micro nozzles on the nozzle body 32 have a cross sectional area of about 1.54 square mm or less, such that the individual micro nozzles are over 30 times smaller than system pipe. It is to be appreciated that the dimensions described above are merely examples and that the ratio of the micro nozzles and the water supply pipe is exemplary. The ratio may vary depending on the particular application and specifications. In some embodiments, the ratio is at least about 10, with the individual micro nozzles being at least about 10 times smaller (in cross-sectional area) than the water supply pipe. In one embodiment, the micro nozzles are drilled to a diameter of equal to or less than about 2 mm. In some embodiments, the micro nozzle diameter ranges from between about 0.5 mm to about 0.7 mm.

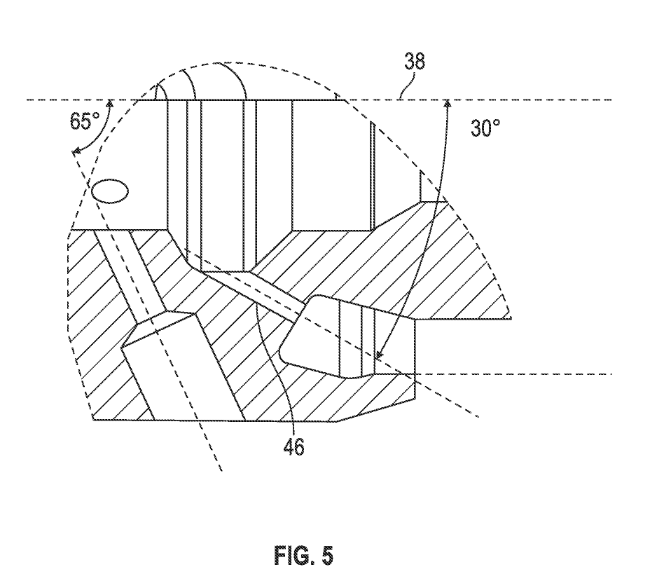

The nozzle 42 includes an annular groove 44 that extends circumferentially about the nozzle body 32. A hole 46 extends between, and fluidly couples, the water plenum 34 and the annular groove 44. The hole 46 is positioned to route the fire suppression fluid from the water plenum 34 to the annular groove 44 at an angle relative to the central axis 38 of the nozzle body 32. In one embodiment, the angle ranges from about 15 degrees to about 50 degrees. In another embodiment, the angle is about 30 degrees (FIG. 5), but alternative angular orientations are contemplated. The annular groove 44 is defined by an axial wall portion 48, a radially inner wall portion 50, and a radially outer wall portion 52. The hole 46 is formed in the axial wall portion 48 and oriented perpendicularly to the axial wall portion 48.

The hole 46 defines a fluid flow path and results in a jet path in the annular groove 44. A portion of the radially outer wall portion 52 is angularly oriented relative to the remainder of the radially outer wall portion 52 to define what is referred to as a deflector lip 54 (FIGS. 3 and 4). The jet path that comprises the expelled fluid flow path intersects with the deflector lip 54 to ensure that the fluid being expelled through the hole 46 contacts the deflector lip 54 and is deflected accordingly. The deflection of the fluid is in a direction consistent with facilitation of formation of the primary trajectory 36 described in detail above. The radially outer wall portion 52 is formed of multiple segments, such as a first segment 56 and a second segment 58, with the second segment comprising the deflector lip 54 and angled from the first segment 56. Exemplary embodiments of the deflector lip 54 are illustrated in FIGS. 3 and 4, but it is to be appreciated that the precise orientation of the deflector lip 54 is not limited by the illustrated embodiments and may comprise variations thereof.

Although a single nozzle is described above, it is to be appreciated that a plurality of nozzles may be included about the circumference of the nozzle body 32, thereby forming a plurality of outlets about the nozzle body 32 from which fire suppression fluid may be ejected. In particular, in some embodiments the water mist nozzle arrangement is comprised of a plurality of micro nozzle holes and a deflector lip which are all contained in the same body.

As shown, in addition to the primary trajectory 36, the fire suppression water spray device 30 includes additional nozzles that may be referred to as secondary nozzles 60. The secondary nozzles 60 are oriented to eject fluid in a downward and radially outward direction from the nozzle body 32. In one embodiment, the secondary nozzles 60 are angularly oriented from the central axis 38 at an angle of about 65 degrees, but variations are contemplated depending on the particular application.

The above-described structure advantageously overcomes manufacturing challenges associated with forming a single, uniformly and integrally constructed nozzle that is configured to eject fluid in the primary trajectory 36 that was previously accepted as a “dead zone.” In particular, a method of forming the fire suppression water spray device 30 is provided.

The method includes integrally forming the bulb cage with the nozzle body 32. Integrally forming the bulb cage with the nozzle body 32 may include any joining process, such as casting, welding, brazing, and chemical dissolution, for example. These are merely exemplary processes, and it is to be appreciated that the above-described processes are merely illustrative and not intended to be limiting. The annular groove 44 is machined into the nozzle body 32. It is to be appreciated that numerous groove profiles may be machined. The annular groove 44 facilitates a region in which the hole 46 can be drilled. In particular, a drill bit is inserted into the annular groove 44 and the hole 46 is drilled through the nozzle body 32 to the water plenum 34. The hole angle is perpendicular to the axial wall portion 48, as described in detail above, but as noted the configuration of the annular groove 44 and therefore the axial wall portion 48 may vary. The deflector lip 54 is thus integrally formed within the annular groove 44 proximate an outlet of the nozzle 42. The deflector lip 54 is formed by pressure turning the nozzle body 32 and the resulting deflector lip 54 facilitates deflection of the spray downwards about the bulb cage 40.

Advantageously, the bulb cage 40 is machined to be integrally formed with the nozzle body 32, thereby reducing assembly complexity and avoiding re-assembly after use of the fire suppression water spray device 30, as is needed in a separable bulb cage arrangement. Additionally, the deflector lip 54 is integrally formed with the nozzle body 32. This allows combining the manufacturing of the deflector lip 54 with the same machining phase as the rest of the nozzle body manufacturing. Therefore, the deflector does not require separate assembly or parts and the manufacturing can be integrated to a CNC machining program of the overall nozzle body 32.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A water mist fire suppression device comprising:
a nozzle body disposed about a central axis;
a nozzle arrangement configured to expel water, the nozzle arrangement comprising:
an annular groove circumferentially extending about the central axis proximate an outlet of the nozzle arrangement;
a micro nozzle extending from a water plenum to the annular groove, wherein the micro nozzle is angularly oriented from the central axis; and
a deflector lip located proximate the outlet of the nozzle arrangement, wherein the deflector lip is positioned to contact water ejected from the micro nozzle and prior to exiting the outlet of the nozzle arrangement.

2. The water mist fire suppression device of claim 1, wherein the micro nozzle is angularly oriented from the central axis at an angle of about 15 degrees to about 50 degrees.

3. The water mist fire suppression device of claim 1, wherein the annular groove is at least partially defined by an axial wall portion, a radially inner wall portion, and a radially outer wall portion, wherein the micro nozzle extends through the axial wall portion.

4. The water mist fire suppression device of claim 3, wherein the micro nozzle is aligned perpendicularly to the axial wall portion of the annular groove.

5. The water mist fire suppression device of claim 3, wherein the deflector lip is formed on the radially outer wall portion.

6. The water mist fire suppression device of claim 5, wherein the micro nozzle is configured to route water from the water plenum to the annular groove, the micro nozzle aligned to expel the water into the annular groove in a direction that contacts the deflector lip.

7. The water mist fire suppression device of claim 3, wherein the radially outer wall portion comprises a first segment and a second segment, the second segment forming the deflector lip.

8. The water mist fire suppression device of claim 7, wherein the second segment is angularly displaced from the first segment.

9. The water mist fire suppression device of claim 1, further comprising a plurality of nozzles, each of the nozzles comprising the annular groove, the micro nozzle and the deflector lip.

10. A method of manufacturing a water mist fire suppression device comprising:
machining a bulb cage to be integrally formed with a nozzle body;
machining an annular groove about a central axis of the nozzle body;
drilling at least one micro nozzle through the nozzle body from the annular groove to a water plenum of the nozzle body; and
integrally forming a deflector lip within the annular groove proximate an outlet of a nozzle arrangement, wherein the deflector lip is positioned to interfere with a water spray exiting the at least one micro nozzle.

11. The method of claim 10, wherein machining the annular groove comprises forming an axial wall portion, a radially inner wall portion, and a radially outer wall portion.

12. The method of claim 11, wherein drilling the at least one micro nozzle comprises drilling through the axial wall portion to the water plenum at an angle perpendicular to the axial wall portion.

13. The method of claim 11, wherein integrally forming the deflector lip comprises pressure turning a portion of the radially outer wall portion.

14. The method of claim 11, wherein integrally forming the deflector lip forms a first segment of the radially outer wall portion and a second segment of the radially outer wall portion, the second segment angularly oriented relative to the first segment.

15. The method of claim 10, wherein drilling the at least one micro nozzle comprises drilling the micro nozzle at an angle of about 15 degrees to about 50 degrees relative to the central axis of the nozzle body.

16. The method of claim 10, wherein integrally forming the deflector lip comprises positioning the deflector lip to redirect a water spray expelled from the micro nozzle.
